(19) United States
(12) Patent Application Publication
(10) Pub. No.: US 2024/0267767 A1
(43) Pub. Date: Aug. 8, 2024

(54) State detection method and apparatus, terminal, and storage medium

(71) Applicant: TP-Link Corporation Limited, Hong Kong (CN)

(72) Inventor: Xiana LIN, Chengdu, Sichuan (CN)

(21) Appl. No.: 18/563,947

(22) PCT Filed: May 31, 2023
(86) PCT No.: PCT/CN2023/097519

§ 371 Date: Nov. 24, 2023

(30) Foreign Application Priority Data
Aug. 18, 2022 (CN) 202210991535.4

(51) Int. Cl. H04W 24/08

(52) U.S. Cl. CPC H04W 24/08

(57) ABSTRACT

The present disclosure discloses a state detection method and apparatus, a terminal, and a storage medium. The method includes: obtaining channel metric data of a device in a target scenario; determining channel change degree metric data based on the channel metric data; determining, based on the channel change degree metric data and environmental metric data, a state detection threshold corresponding to the target scenario; and detecting a target state of the device in the target scenario according to the state detection threshold and the channel change degree metric data.

### CROSS-REFERENCE TO RELATED APPLICATIONS

The present disclosure claims the priority of Chinese Patent Application No. 202210991535.4, filed to the China National Intellectual Property Administration on Aug. 18, 2022 and entitled “state detection method and apparatus, a terminal, and a storage medium”, which is incorporated herein its entirety by reference.

### TECHNICAL FIELD

The present disclosure relates to the field of wireless communication technology, and in particular to a state detection method and apparatus, a terminal, and a storage medium.

### BACKGROUND

Due to the rapid development of location services, there has been a gradual increase in demand for mobile detection services for devices, especially for mobile detection services for devices being in communication connection with a wireless access point (AP). When the device moves, a channel environment between the device and the wireless AP changes, which increases the difficulty in device state detection. Therefore, how to accurately detect the state of the device has become an urgent problem.

Currently, location detection or signal change detection is commonly used to obtain the state of the device. In location detection, algorithms are adopted to predict whether the device is in a motion state, while in signal change detection, simple filtering operations and fixed thresholds are adopted to judge whether the device moves.

However, these methods are unable to accurately detect the state of the device in different scenarios.

### SUMMARY

In a first aspect, the present disclosure provides a state detection method, including: channel metric data of a device in a target scenario is obtained;
channel change degree metric data is determined based on the channel metric data;
a state detection threshold corresponding to the target scenario is determined based on the channel change degree metric data and environmental metric data; and
a target state of the device in the target scenario is detected according to the state detection threshold and the channel change degree metric data.

In an embodiment, the step of determining a state detection threshold corresponding to the target scenario based on the channel change degree metric data and environmental metric data includes:
target environmental metric data and a mapping function are determined based on the channel change degree metric data and the environmental metric data, where the mapping function is used for representing a mapping relationship between the channel change degree metric data and the environmental metric data; and
the target environmental metric data is input into the mapping function to output a state detection threshold.

In an embodiment, the step of determining target environmental metric data and a mapping function based on the channel change degree metric data and the environmental metric data includes:
distribution parameters are extracted from the environmental metric data;
a first preset method is utilized for calculating correlation between the distribution parameters and the channel change degree metric data, and the distribution parameters corresponding to the maximum correlation value is adopted as the target environmental metric data; and
a second preset method is utilized for performing fitting on the target environmental metric data and the channel change degree metric data to obtain a mapping function.

In an embodiment, the step of detecting a target state of the device in the target scenario according to the state detection threshold and the channel change degree metric data includes:
the state detection threshold and the channel change degree metric data are compared;
the device is in a motion state in the target scenario on the condition that the state detection threshold is less than the channel change degree metric data; and
the device is in a stationary state in the target scenario on the condition that the state detection threshold is greater than the channel change degree metric data.

In an embodiment, the channel metric data includes RSSI data at the n^{th} moment and/or CSI data at the n^{th} moment, and the channel change degree metric data includes RSSI variation metric data at the n^{th} moment and/or CSI variation metric data at the n^{th} moment.

The step of determining channel change degree metric data based on the channel metric data includes:
in the case of n=1, noise reduction processing is performed on RSSI data at the n^{th} moment, and based on the processed RSSI data, RSSI variation metric data at the n^{th} moment is determined; and
based on CSI data at the n^{th} moment, CSI variation metric data at the n^{th} moment is determined.

In an embodiment, the channel metric data includes RSSI data at the n^{th} moment and/or CSI data at the n^{th} moment, and the channel change degree metric data includes RSSI variation metric data at the n^{th} moment and/or CSI variation metric data at the n^{th} moment.

The step of determining channel change degree metric data based on the channel metric data includes:
in the case of n being an integer greater than or equal to 2, noise reduction processing is performed on RSSI data at the n^{th} moment, the processed RSSI data is subtracted from RSSI data at the (n−1)^{th} moment to obtain difference data, and the difference data is adopted as RSSI variation metric data at the n^{th} moment; and
CSI data at the n^{th} moment and CSI data at the (n−1)^{th} moment are processed, and the processed CSI data is adopted as CSI variation metric data at the n^{th} moment.

In an embodiment, the channel change degree metric data includes at least one of RSSI variation metric data and CSI variation metric data.

In a second aspect, an embodiment of the present disclosure provides a state detection apparatus, including:
a data acquisition component, configured to obtain channel metric data of a device in a target scenario;
a variation determining component, configured to determine channel change degree metric data based on the channel metric data;
a threshold determining component, configured to determine a state detection threshold corresponding to the target scenario based on the channel change degree metric data and environmental metric data; and
a state detection component, configured to detect a target state of the device in the target scenario according to the state detection threshold and the channel change degree metric data.

In a third aspect, an embodiment of the present disclosure provides a terminal. The terminal includes a memory, a processor, and a computer program stored on the processor and runnable on the processor. The processor, when executing the computer program, implements the steps of any above state detection method.

In a fourth aspect, an embodiment of the present disclosure provides a computer-readable storage medium. The computer-readable storage medium stores a computer program. The computer program, when executed by a processor, implements the steps of any above state detection method.

### BRIEF DESCRIPTION OF THE DRAWINGS

The accompanying drawings constituting a part of the present disclosure are used to provide further understanding of the present disclosure, thereby making other features, objectives, and advantages of the present disclosure more apparent. The illustrative embodiment accompanying drawings and descriptions thereof in the present disclosure are used to explain the present disclosure, but do not constitute improper limitations on the present disclosure. In the accompanying drawings:

FIG. 1 is a diagram of an application scenario of a state detection method according to an embodiment of the present disclosure;

FIG. 2 is a flowchart of implementing a state detection method according to an embodiment of the present disclosure;

FIG. 3 is a schematic diagram of a relationship of a mapping function according to an embodiment of the present disclosure;

FIG. 4 is a structural schematic diagram of a state detection apparatus according to an embodiment of the present disclosure; and

FIG. 5 is a schematic diagram of a terminal according to an embodiment of the present disclosure.

### DETAILED DESCRIPTION OF THE EMBODIMENTS

To make objectives, technical solutions and advantages of embodiments of the present disclosure more clear, the technical solutions in the embodiments of the present disclosure are clearly and integrally described in conjunction with the accompanying drawings in the embodiments of the present disclosure as below, and it is apparent that the described embodiments are only a part rather all of embodiments. Based on the embodiments of the present disclosure, all other embodiments obtained by those of ordinary skill in the art without contributing creative labor shall fall within the scope of protection of the present disclosure.

The terms such as “first”, “second”, “third”, and “fourth” (if any) in the specification and claims of the present disclosure and in the above accompanying drawings are used for distinguishing similar objects but not necessarily used for describing any particular order or sequence. It is to be understood that data used in this way can be exchanged under proper situations so that the described embodiments of the present disclosure can be implemented in sequence other than that illustrated or described here.

It is to be understood that the serial numbers of various processes in the various embodiments of the present disclosure do imply an execution sequence, and the execution sequence of the various processes is determined according to functions and internal logics, which cannot limit an implementation process of the embodiments of the present disclosure.

It is to be understood that the terms “include”, “have” and any variations thereof in the present disclosure are intended to cover the non-exclusive inclusion. For example, a process, method, system, product, or device that includes a series of steps or units is not necessarily limited to those expressly listed steps or units, but may include other steps or units not expressly listed or inherent to the process, method, system, product, or device.

It is to be understood that “a plurality of” in the present disclosure refers to two or more. The term “and/or” is only an association relationship for describing associated objects, indicating that there may be three relationships, for example, A and/or B may represent three situations: A exists alone, both A and B exist, and B exists alone. The character “/” generally indicates an “or” relationship between the associated objects before and after it. The phrases “including A, B, and C”, and “including A, B, and C” both refer to the inclusion of A, B, and C altogether. The phrase “including A, B, or C” refers to the inclusion of one of A, B, and C. The phrase “including A, B, and/or C” refers to the inclusion of any one, any two, or three of A, B, and C.

It is to be understood that in the present disclosure, the phrase “B corresponding to A”, “B associated with A”, “A and B are in correspondence”, or “B and A are in correspondence” represents that B and A are associated, and B can be determined according to A. Determining B based on A does not imply that B is determined only based on A, and may also be determined based on A and/or other information. The matching between A and B is defined as the similarity between A and B being greater than or equal to a preset threshold.

According to the context, for example, the word “if” used herein may be explained as “during”, or “when”, or “in response to determining”, or “in response to detecting”.

The technical solutions of the present disclosure are described in detail according to specific embodiments. The following specific embodiments can be combined, and same or similar concepts or processes may not be repeated in some embodiments.

To make the objectives, technical solutions and advantages of the present disclosure more clear, the description is made by the specific embodiments in conjunction with the accompanying drawings.

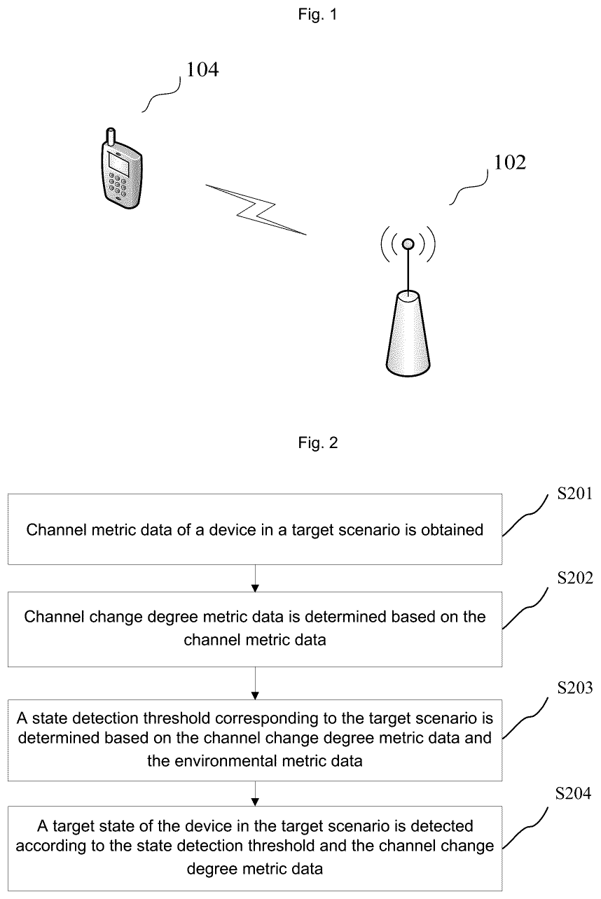

The present disclosure provides a state detection method which can be applied to an application environment shown in FIG. 1. A wireless access point (AP) 102 obtains channel metric data of a device 104 in a target scenario, then, determines channel change degree metric data based on the channel metric data, determines a state detection threshold corresponding to the target scenario based on the channel change degree metric data and environmental metric data, and detects a target state of the device in the target scenario according to the state detection threshold and the channel change degree metric data. The wireless AP 102 is in wireless communication with the device 104. The device 104 is any device capable of being in wireless communication with the wireless AP 102, such as a user computer, or other clients, and a cloud server.

In an embodiment, as shown in FIG. 2, a state detection method is provided and applied to the scenario shown in FIG. 1, and includes the following steps:

Step S201: Channel metric data of a device in a target scenario is obtained.

The target scenario is mainly used for representing different channel environments in which the device is located, such as shielded environments, home environments (including scenarios such as areas, spaciousness, fullness, and different building materials), densely deployed scenarios (e.g., shopping malls, stadiums, and parks), outdoor scenarios, and other scenarios.

Channel metrics are variables used to measure channel environment changes, such as a received signal strength indicator (RSSI), latency, throughput, a transmission rate, channel state information (CSI), and a packet loss rate. Due to the large variability in latency jitter, the latency has a low accuracy rate when used to measure the channel environment. The throughput and the packet loss rate have a high reference value when the device has a certain traffic behavior. However, the RSSI and the CSI are easy to obtain in real time, and directly reflect the current channel environment. Therefore, the present disclosure utilizes RSSI data and CSI data as the channel metric data. In other words, for any channel environment, the channel metric data obtained by the wireless AP 102 is the RSSI data and the CSI data in the channel environment.

Step S202: Channel change degree metric data is determined based on the channel metric data.

The channel metric data includes at least one of the RSSI data and the CSI data, where the RSSI data is RSSI data when the device is in motion or stationary, and the CSI data is CSI data when the device is in motion or stationary. The channel change degree metric refers to the degree of change in variables that measure channel environment changes. The channel change degree metric data includes at least one of RSSI variation metric data and CSI variation metric data.

Because the device state detection put forwards in the present disclosure is performed in real time, the device obtains the channel metric data in the target scenario at each time, and determines, based on the channel metric data at each time, the channel change degree metric data at each time. Therefore, the process of determining the channel change degree metric data based on the channel metric data is elaborated on the basis of time changes, which is specifically as below:

in some embodiments, the step of determining channel change degree metric data based on channel metric data includes: in the case of n=1, noise reduction processing is performed on RSSI data at the n^{th} moment, and based on the processed RSSI data, RSSI variation metric data at the n^{th} moment is determined; and based on CSI data at the n^{th} moment, CSI variation metric data at the n^{th} moment is determined. The channel metric data includes the RSSI data at the n^{th} moment and/or the CSI data at the n^{th} moment, and the channel change degree metric data includes the RSSI variation metric data at the n^{th} moment and/or the CSI variation metric data at the n^{th} moment.

Specifically, at the first moment, when the channel metric data is RSSI data at the first moment, the wireless AP 102 performs noise reduction processing on the RSSI data at the first moment, and obtains, based on the processed RSSI data, RSSI variation metric data at the first moment, where the noise reduction processing method includes but not limited to mean filtering, Gaussian filtering, etc. Similarly, at the first moment, when the channel metric data is CSI data at the first moment, the wireless AP 102 determines, based on the CSI data at the first moment, CSI variation metric data at the first moment.

At the first moment, when the channel metric data includes the RSSI data and the CSI data at the first moment, the wireless AP 102 respectively obtains, based on the RSSI data and the CSI data at the first moment, the RSSI variation metric data and the CSI variation metric data at the first moment. The method for determining the RSSI variation metric data based on the RSSI data and determining the CSI variation metric data based on the CSI data is the same as above, which is not repeated herein.

In some other embodiments, the step of determining channel change degree metric data based on channel metric data includes: in the case of n being an integer greater than or equal to 2, noise reduction processing is performed on RSSI data at the n^{th} moment, the processed RSSI data is subtracted from RSSI data at the (n−1)^{th} moment to obtain difference data, and the difference data is adopted as RSSI variation metric data at the n^{th} moment; and CSI data at the n^{th} moment and CSI data at the (n−1)^{th} moment are processed, and the processed CSI data is adopted as CSI variation metric data at the n^{th} moment. The channel metric data includes the RSSI data at the n^{th} moment and/or the CSI data at the n^{th} moment, and the channel change degree metric data includes the RSSI variation metric data at the n^{th} moment and/or the CSI variation metric data at the n^{th} moment.

Specifically, at the second moment, when the channel metric data is RSSI data at the second moment, the wireless AP 102 performs noise reduction processing on the RSSI data at the second moment, the processed RSSI data is subtracted from the RSSI data at the first moment to obtain difference data, and the difference data is adopted as RSSI variation metric data at the second moment. Similarly, at the second moment, when the channel metric data is CSI data at the second moment, the wireless AP 102 processes the CSI data at the second moment and the CSI data at the first moment, and the processed CSI data is adopted as CSI variation metric data at the second moment, where the processing method includes but not limited to covariance, cosine similarity, the Pearson correlation coefficient, time reversal focusing, autocorrelation, etc.

At the second moment, when the channel metric data includes the RSSI data and the CSI data at the second moment, the wireless AP 102 respectively obtains, based on the RSSI data and the CSI data at the second moment, the RSSI variation metric data and the CSI variation metric data at the second moment. The method for determining the RSSI variation metric data based on the RSSI data and determining the CSI variation metric data based on the CSI data is the same as the calculation method at the second moment, which is not repeated herein.

Only the method for calculating the channel change degree metric data at the second moment is specifically described above, and the method for calculating the channel change degree metric data at any moment after the second moment, such as the third moment and the fourth moment is similar to the method for calculating the channel change degree metric data at the second moment, which is not repeated herein.

Step S203: A state detection threshold corresponding to the target scenario is determined based on the channel change degree metric data and the environmental metric data.

The environmental metric data refers to environment-related statistical data for the wireless AP in different scenarios, including but not limited to plcp detection errors, an AP idle time ratio, background noise, a proportion of receiving data packets from other basic service sets (BSSs), a physical (PHY) layer packet parsing error rate, channel utilization, etc.

After the channel change degree metric data is obtained, the wireless AP 102 determines, based on the channel change degree metric data and the environmental metric data, the state detection threshold corresponding to the target scenario, and primarily determines target environmental metric data and a mapping function based on the channel change degree metric data and the environmental metric data. Specifically, distribution parameters are firstly extracted from the environmental metric data, then, a first preset method is utilized for calculating correlation between the distribution parameters and the channel change degree metric data, the distribution parameters corresponding to the maximum correlation value are adopted as the target environmental metric data, and then a second preset method is utilized for fitting the target environmental metric data and the channel change degree metric data to obtain the mapping function. The mapping function is used for representing a mapping relationship between the channel change degree metric data and the environmental metric data.

After the target environmental metric data and the mapping function are determined, the target environmental metric data is input into the mapping function to output the state detection threshold. In the present disclosure, the state detection threshold is adaptively adjusted according to the channel change degree metric data and the environmental metric data, thereby improving state detection precision and accuracy in different scenarios.

The process of determining the state detection threshold corresponding to the target scenario based on the channel change degree metric data and the environmental metric data is specifically elaborated as below with the channel change degree metric data being the RSSI variation metric data as an example:

in the present disclosure, the wireless AP 102 analyzes and compares the environmental metric data and the RSSI variation metric data in different scenarios so as to select the target environmental metric data through which the different scenarios can be distinguished, and based on the target environmental metric data and the RSSI variation metric data, the corresponding relationship between the state detection threshold and the scenario is determined, that is, the state detection threshold in different scenarios is determined.

The wireless AP 102 first extracts the corresponding distribution parameters from the environmental metric data in different scenarios, where the distribution parameters can be separably or jointly distributed, such as the mean of background noise, and the joint distribution parameters of background noise and the AP idle time ratio. Then, correlation calculation is performed on the distribution parameters and the RSSI variation metric data in different scenarios so as to obtain calculation results in different scenarios, where the correlation calculation may be determined using common methods of correlation analysis, including but not limited to a graph analysis method, covariance matrix, a correlation coefficient method, a regression method, an information entropy method, etc. After the calculation results in different scenarios are obtained, the distribution parameters corresponding to the maximum correlation value in the calculation results are adopted as the target environmental metric data, thereby determining the target environmental metric data in different scenarios.

Specifically, taking the correlation coefficient method as an example, the distribution parameters (e.g., the mean of background noise) and the RSSI variation metric data are adopted as one-to-one correspondence points according to the scenario, and the correlation coefficient (e.g., Pearson and Spearman) is then calculated. After completing the correlation coefficient calculation for all scenarios, one or more parameters with high correlation (e.g., the result coefficient is closer to 1) are selected from each scenario as the target environmental metric data for this scenario.

After the target environmental metric data for each scenario is determined, fitting is performed on the target environmental metric data and the RSSI variation metric data at the first moment to obtain the mapping function, that is, the mapping relationship between the RSSI variation metric data at the first moment and the target environmental metric data is parsed to serve as a basis for adjusting the state detection threshold. The parsing method may include but not limited to methods such as linear fitting, data fitting, and regression. After the mapping function is obtained, the target environmental metric data is adopted as an input to be substituted into the mapping function, and an output is adopted as the state detection threshold.

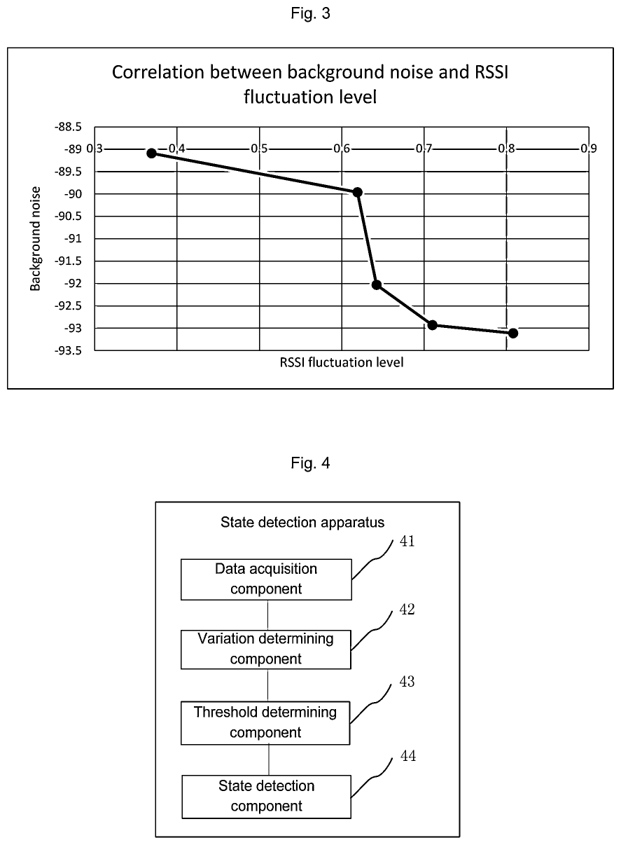

Taking FIG. 3 as an example, it is assumed that according to the mapping function, the relationship between background noise and the RSSI variation metric data Δrssi is obtained through logarithmic fitting, which is specifically: background noise=−5.274 ln(Δrssi)−94.036. Based on the above mapping relationship, the relationship between the background noise and the RSSI variation metric data Δrssi (i.e., the RSSI fluctuation level) can be known. In the present disclosure, the RSSI variation metric data Δrssi is considered as the state detection threshold when the real-time background noise equals x.

The above method for determining the state detection threshold is only an example. The fitting method is not limited to logarithmic fitting, and other methods such as linear fitting or regression can also yield suitable fitting equations or tables. The adjustment of the state detection threshold is not limited to a single threshold. For example, if the mobility state of the device is defined in multiple ways, a plurality of corresponding thresholds may also be divided.

It is to be noted that when the channel change degree metric data is the CSI variation metric data, the method for determining the state detection threshold corresponding to the target scenario is similar to the method when the channel change degree metric data is the RSSI variation metric data, which is not repeated herein.

Step S204: A target state of the device in the target scenario is detected according to the state detection threshold and the channel change degree metric data.

After the state detection threshold is determined, the target state of the device in the target scenario is detected according to the state detection threshold and the channel change degree metric data. Specifically, the state detection threshold and the channel change degree metric data are compared, if the state detection threshold is less than the channel change degree metric data, the device is in the motion state in the target scenario, and if the state detection threshold is greater than the channel change degree metric data, the device is in the stationary state in the target scenario.

Taking the mapping function as an example: background noise=−5.274 ln(Δrssi)−94.036, when the real-time background noise is x, the calculated Δrssi is adopted as the state detection threshold. Then, the state detection threshold is compared with the RSSI variation metric data processed in real time, and if the RSSI variation metric data processed in real time is less than the state detection threshold, it indicates that the device is in the stationary state, or otherwise, the device is in the motion state.

This embodiment of the present disclosure provides the state detection method. The state detection method includes: the channel metric data of the device in the target scenario is obtained, the channel change degree metric data is determined based on the channel metric data, then, the state detection threshold corresponding to the target scenario is determined based on the channel change degree metric data and the environmental metric data, and finally, the target state of the device in the target scenario is detected according to the state detection threshold and the channel change degree metric data. The present disclosure utilizes the channel metric data, such as RSSI and CSI for measuring the channel change degree of the device, and utilizes the environmental metric data for analyzing the current wireless environment, such that the state detection threshold can be adaptively adjusted in real time in different scenarios, thereby realizing device state detection. The present disclosure is simple, convenient and applicable to different scenarios, and also improves the accuracy of device state detection.

It is to be understood that the serial numbers of various steps in the above embodiments do indicate an execution sequence, and the execution sequence of various processes is determined according to functions and internal logics, which cannot limit an implementation process of the embodiments of the present disclosure.

The following is an apparatus embodiment of the present disclosure, and for details not fully described herein, reference may be made to the above corresponding method embodiments.

FIG. 4 illustrates a structural schematic diagram of a state detection apparatus according to an embodiment of the present disclosure. To facilitate the description, only the part related to this embodiment of the present disclosure is shown. The state detection apparatus includes a data acquisition component 41, a variation determining component 42, a threshold determining component 43, and a state detection component 44, which are specifically as below:

The data acquisition component 41 is configured to obtain channel metric data of a device in a target scenario;
the variation determining component 42 is configured to determine channel change degree metric data based on the channel metric data;
the threshold determining component 43 is configured to determine a state detection threshold corresponding to the target scenario based on the channel change degree metric data and environmental metric data; and
the state detection component 44 is configured to detect a target state of the device in the target scenario according to the state detection threshold and the channel change degree metric data.

In an embodiment, the threshold determining component 43 includes:
a function determining subcomponent, configured to determine target environmental metric data and a mapping function based on the channel change degree metric data and the environmental metric data, where the mapping function is used for representing a mapping relationship between the channel change degree metric data and the environmental metric data; and
a threshold determining subcomponent, configured to input the target environmental metric data into the mapping function to output a state detection threshold.

In an embodiment, the function determining subcomponent includes:
a parameter extraction unit, configured to extract distribution parameters from the environmental metric data;
an environmental metric determining unit, configured to utilize a first preset method for calculating correlation between the distribution parameters and the channel change degree metric data, and take the distribution parameters corresponding to the maximum correlation value as the target environmental metric data; and
a function determining unit, configured to utilize a second preset method for fitting the target environmental metric data and the channel change degree metric data to obtain a mapping function.

In an embodiment, the state detection component 44 includes:
a data comparison subcomponent, configured to compare the state detection threshold with the channel change degree metric data;
a motion state determining subcomponent, configured to determine that the device is in a motion state in the target scenario if the state detection threshold is less than the channel change degree metric data; and
a stationary state determining subcomponent, configured to determine that the device is in a stationary state in the target scenario if the state detection threshold is greater than the channel change degree metric data.

In an embodiment, the channel metric data includes RSSI data at the n^{th} moment and/or CSI data at the n^{th} moment, and the channel change degree metric data includes RSSI variation metric data at the n^{th} moment and/or CSI variation metric data at the n^{th} moment.

The variation determining component 42 includes:
a first variation determining subcomponent, configured to perform, in the case of n=1, noise reduction processing on RSSI data at the n^{th} moment, and determine, based on the processed RSSI data, RSSI variation metric data at the n^{th} moment; and
a second variation determining subcomponent, configured to determine, based on CSI data at the n^{th} moment, CSI variation metric data at the n^{th} moment.

In an embodiment, the channel metric data includes RSSI data at the n^{th} moment and/or CSI data at the n^{th} moment, and the channel change degree metric data includes RSSI variation metric data at the n^{th} moment and/or CSI variation metric data at the n^{th} moment.

The variation determining component 42 includes:
a third variation determining subcomponent, configured to perform, in the case of n being an integer greater than or equal to 2, noise reduction processing on RSSI data at the n^{th} moment, subtract the processed RSSI data from RSSI data at the (n−1)^{th} moment to obtain difference data, and take the difference data as RSSI variation metric data at the n^{th} moment; and
a fourth variation determining subcomponent, configured to process CSI data at the n^{th} moment and CSI data at the (n−1)^{th} moment, and take the processed CSI data as CSI variation metric data at the n^{th} moment.

In an embodiment, the channel change degree metric data includes at least one of RSSI variation metric data and CSI variation metric data.

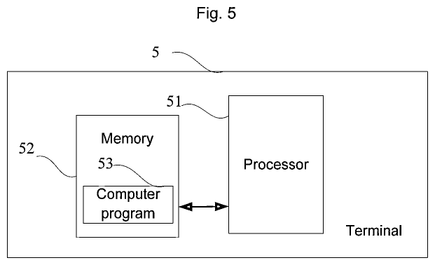

FIG. 5 is a schematic diagram of a terminal according to an embodiment of the present disclosure. As shown in FIG. 5, the terminal 5 in this embodiment includes a processor 51, a memory 52, and a computer program 53 stored on the memory 52 and runnable on the processor 51. The processor 51, when executing the computer program 53, implements the steps in the embodiments of the state detection methods, such as step 201 to step 204 shown in FIG. 2. Alternatively, the processor 51, when executing the computer program 53, implements the functions of the components/units in the embodiments of the state detection methods, such as the functions of the components/units 41 to 44 shown in FIG. 4.

The present disclosure further provides a readable storage medium. The readable storage medium stores a computer program. The computer program, when executed by a processor, implements the state detection methods provided in the above various implementations.

The readable storage medium may be a computer storage medium, or a communication medium. The communication medium includes any medium that facilitates a computer program to be transmitted from one place to another. The computer storage medium may be any available medium accessible to a general-purpose or dedicated computer. For example, the readable storage medium is coupled to the processor, such that the processor can read information from the readable storage medium and write information into the readable storage medium. Certainly, the readable storage medium may also be a part of the processor. The processor and the readable storage medium may be located in application specific integrated circuits (ASICs). In addition, the ASIC may be located in user equipment. Certainly, the processor and the readable storage medium may also exist in a communication device as discrete components. The readable storage medium may be a read only memory (ROM), a random access memory (RAM), a compact disc read only memory (CD-ROM), a magnetic tape, a floppy disk, an optical data storage device, etc.

The present disclosure further provides a program product. The program product includes executable instructions stored in a readable storage medium. At least one processor of the device may read the executable instructions from the readable storage medium, and execute the executable instructions, thereby making the device implement the state detection methods provided in the above various implementations.

In the embodiments of the device, it is to be understood that the processor may be a central processing unit (CPU), or other general-purpose processors, a digital signal processor (DSP), an application specific integrated circuit (ASIC), etc. The general-purpose processor may be a microprocessor, or any conventional processor, etc. The steps of the method disclosed in conjunction with the present disclosure may be directly implemented by a hardware processor, or implemented by a combination of a hardware component and a software component in the processor.

The above embodiments are merely used for describing rather than limiting the technical solutions of the present disclosure; although the present disclosure has been described in detail with reference to the foregoing various embodiments, those of ordinary skill in the art should understand that the technical solutions recorded in the foregoing various embodiments can still be modified, or some of the technical features therein can be equivalently substituted; and such modifications or substitutions do not make the essence of the corresponding technical solutions depart from the spirit and scope of the technical solutions of the various embodiments of the present disclosure, which shall fall within the scope of protection of the present disclosure.

1. A state detection method, comprising:
obtaining channel metric data of a device in a target scenario;
determining channel change degree metric data based on the channel metric data;
determining, based on the channel change degree metric data and environmental metric data, a state detection threshold corresponding to the target scenario; and
detecting a target state of the device in the target scenario according to the state detection threshold and the channel change degree metric data.

2. The state detection method according to claim 1, wherein determining, based on the channel change degree metric data and the environmental metric data, the state detection threshold corresponding to the target scenario comprises:
determining target environmental metric data and a mapping function based on the channel change degree metric data and the environmental metric data, wherein the mapping function is used for representing a mapping relationship between the channel change degree metric data and the environmental metric data; and
inputting the target environmental metric data into the mapping function to output the state detection threshold.

3. The state detection method according to claim 2, wherein determining the target environmental metric data and the mapping function based on the channel change degree metric data and the environmental metric data comprises:
extracting distribution parameters from the environmental metric data;
utilizing a first preset method for calculating correlation between the distribution parameters and the channel change degree metric data, and taking the distribution parameters corresponding to the maximum correlation value as the target environmental metric data; and
utilizing a second preset method for performing fitting on the target environmental metric data and the channel change degree metric data to obtain the mapping function.

4. The state detection method according to claim 1, wherein detecting the target state of the device in the target scenario according to the state detection threshold and the channel change degree metric data comprises:
comparing the state detection threshold with the channel change degree metric data;
determining that the device is in a motion state in the target scenario on the condition that the state detection threshold is less than the channel change degree metric data; and
determining that the device is in a stationary state in the target scenario on the condition that the state detection threshold is greater than the channel change degree metric data.

5. The state detection method according to claim 1, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n=1, noise reduction processing on RSSI data at the n^{th} moment, and determining, based on the processed RSSI data, RSSI variation metric data at the n^{th} moment; and
determining, based on CSI data at the n^{th} moment, CSI variation metric data at the n^{th} moment.

6. The state detection method according to claim 1, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n being an integer greater than or equal to 2, noise reduction processing on RSSI data at the n^{th} moment, subtracting the processed RSSI data from RSSI data at the (n−1)^{th} moment to obtain difference data, and taking the difference data as RSSI variation metric data at the n^{th} moment; and
processing CSI data at the n^{th} moment and CSI data at the (n−1)^{th} moment, and taking the processed CSI data as CSI variation metric data at the n^{th} moment.

7. The state detection method according to claim 1, wherein the channel change degree metric data comprises at least one of RSSI variation metric data and CSI variation metric data.

8. (canceled)

9. A terminal, comprising a memory, a processor, and a computer program stored on the processor and runnable on the processor, wherein the processor, when executing the computer program, is enabled to:
obtain channel metric data of a device in a target scenario;
determine channel change degree metric data based on the channel metric data;
determine, based on the channel change degree metric data and environmental metric data, a state detection threshold corresponding to the target scenario; and
detect a target state of the device in the target scenario according to the state detection threshold and the channel change degree metric data.

10. A computer-readable storage medium, wherein the computer-readable storage medium stores a computer program, and when the computer program is executed by a processor, the processor is enabled to:
obtain channel metric data of a device in a target scenario;
determine channel change degree metric data based on the channel metric data;
determine, based on the channel change degree metric data and environmental metric data, a state detection threshold corresponding to the target scenario; and
detect a target state of the device in the target scenario according to the state detection threshold and the channel change degree metric data.

11. The state detection method according to claim 2, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n=1, noise reduction processing on RSSI data at the n^{th} moment, and determining, based on the processed RSSI data, RSSI variation metric data at the n^{th} moment; and
determining, based on CSI data at the n^{th} moment, CSI variation metric data at the n^{th} moment.

12. The state detection method according to claim 3, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n=1, noise reduction processing on RSSI data at the n^{th} moment, and determining, based on the processed RSSI data, RSSI variation metric data at the n^{th} moment; and
determining, based on CSI data at the n^{th} moment, CSI variation metric data at the n^{th} moment.

13. The state detection method according to claim 4, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n=1, noise reduction processing on RSSI data at the n^{th} moment, and determining, based on the processed RSSI data, RSSI variation metric data at the n^{th} moment; and
determining, based on CSI data at the n^{th} moment, CSI variation metric data at the n^{th} moment.

14. The state detection method according to claim 2, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n being an integer greater than or equal to 2, noise reduction processing on RSSI data at the n^{th} moment, subtracting the processed RSSI data from RSSI data at the (n−1)^{th} moment to obtain difference data, and taking the difference data as RSSI variation metric data at the n^{th} moment; and
processing CSI data at the n^{th} moment and CSI data at the (n−1)^{th} moment, and taking the processed CSI data as CSI variation metric data at the n^{th} moment.

15. The state detection method according to claim 3, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n being an integer greater than or equal to 2, noise reduction processing on RSSI data at the n^{th} moment, subtracting the processed RSSI data from RSSI data at the (n−1)^{th} moment to obtain difference data, and taking the difference data as RSSI variation metric data at the n^{th} moment; and
processing CSI data at the n^{th} moment and CSI data at the (n−1)^{th} moment, and taking the processed CSI data as CSI variation metric data at the n^{th} moment.

16. The state detection method according to claim 4, wherein the channel metric data comprises RSSI data at the n^{th} moment and/or CSI data at the n^{th} moment, and the channel change degree metric data comprises RSSI variation metric data at the n^{th} moment and/or CSI variation metric data at the n^{th} moment; and
determining the channel change degree metric data based on the channel metric data comprises:
performing, in the case of n being an integer greater than or equal to 2, noise reduction processing on RSSI data at the n^{th} moment, subtracting the processed RSSI data from RSSI data at the (n−1)^{th} moment to obtain difference data, and taking the difference data as RSSI variation metric data at the n^{th} moment; and
processing CSI data at the n^{th} moment and CSI data at the (n−1)^{th} moment, and taking the processed CSI data as CSI variation metric data at the n^{th} moment.

17. The state detection method according to claim 2, wherein the channel change degree metric data comprises at least one of RSSI variation metric data and CSI variation metric data.

18. The state detection method according to claim 3, wherein the channel change degree metric data comprises at least one of RSSI variation metric data and CSI variation metric data.

19. The state detection method according to claim 4, wherein the channel change degree metric data comprises at least one of RSSI variation metric data and CSI variation metric data.
